(19) United States
(12) Patent Application Publication
(10) Pub. No.: US 2014/0058766 A1
(43) Pub. Date: Feb. 27, 2014

(54) EVENT CALENDAR INTEGRATION

(71) Applicants: Zhou Yu, Shanghai (CN); Qing Guo, Shanghai (CN)

(72) Inventors: Zhou Yu, Shanghai (CN); Qing Guo, Shanghai (CN)

(73) Assignee: eBay Inc., San Jose, CA (US)

(21) Appl. No.: 13/593,276

(22) Filed: Aug. 23, 2012

(51) Int. Cl. G06F 3/01; G06Q 10/02; G06F 15/18

(52) U.S. Cl. 705/5; 715/733; 706/12

(57) ABSTRACT

A method and system to automatically add events to a user's electronic calendar are described. The system may detect that a user has an interest in a particular event by examining user activity outside of an electronic calendar. The system may then automatically, or upon request by the user, add the event to the user's calendar. Additional embodiments are described having various levels of automation in the detection of the user's interest and adding of the event to the user's electronic calendar.

### TECHNICAL FIELD

This application relates to the technical fields of electronic calendars and, in one example embodiment, a system and method to integrate events into electronic calendars.

### BACKGROUND

Electronic calendars have been around since the dawn of the computer age. They have gained even more popularity, however, with the rise of mobile devices and the cloud. Mobile devices such as smartphones allow users to add calendar events no matter where the users are located. Whereas previous electronic calendars running on personal computers (PCs) required a user to remember to enter the event the next time they sit at their computer, with a mobile device the user simply needs to pull out their smartphone and enter the event. Considering that most people carry their smartphones with them at all times, this essentially means the user never has to remember the event longer than the time it takes to pull out the smartphone and enter it. The rise of cloud computing has increased calendar popularity even more, as it is much easier to synchronize calendars located on multiple devices (e.g., smartphone, tablet, laptop computer, desktop computer).

### BRIEF DESCRIPTION OF DRAWINGS

Embodiments of the present invention are illustrated by way of example and not limitation in the figures of the accompanying drawings, in which like reference numbers indicate similar elements and in which:

FIG. 1 is a network diagram depicting a client-server system 500, within which one example embodiment may be deployed.

FIG. 2 is a block diagram illustrating multiple applications 520 and 522 that, in one example embodiment, are provided as part of the networked system 502.

FIG. 3 is a screen capture illustrating an embodiment on a desktop or laptop device, in accordance with one embodiment.

FIG. 4 is a screen capture illustrating an embodiment where the user is prompted to add the event to his or her calendar after purchasing the tickets, in accordance with one embodiment.

FIG. 5 is a screen capture illustrating adding an event to a user calendar, in accordance with one embodiment.

FIG. 6A is a flow diagram illustrating a method, in accordance with one embodiment.

FIG. 6B is a flow diagram illustrating a method, in accordance with another embodiment.

FIG. 7 shows a diagrammatic representation of machine in the example form of a computer system within which a set of instructions, for causing the machine to perform any one or more of the methodologies discussed herein, may be executed.

### DETAILED DESCRIPTION

The description that follows includes illustrative systems, methods, techniques, instruction sequences, and computing machine program products that embody illustrative embodiments. In the following description, for purposes of explanation, numerous specific details are set forth in order to provide an understanding of various embodiments of the inventive subject matter. It will be evident, however, to those skilled in the art that embodiments of the inventive subject matter may be practiced without these specific details. In general, well-known instruction instances, protocols, structures, and techniques have not been shown in detail.

In one embodiment, events are automatically integrated to a user's calendar based on purchase information. In one example, a user may make a purchase on a ticket reseller website. At such a website, concert, sports, and other tickets may be resold to users. These tickets may either be sold by concert or sporting event promoters, or by other users who wish to resell their tickets. Nevertheless, in one embodiment, the date and time of the event for which the user makes a purchase is automatically entered into his or her electronic calendar with the appropriate information about the event.

In other embodiments, the user does not need to make a purchase in order for the event to be added to the calendar. The user could indicate interest in the event in another manner short of an actual purchase, such as viewing the tickets on a web site, adding the tickets to a shopping cart, or indicating an interest in a subscription of events. The latter may be most helpful in the case where the user is a fan of a sports team or concert series, and may wish to be automatically reminded of events related to any of those events. The system can automatically add entries related to the events to the user's calendar. In some embodiments, the subscription settings can be configurable by the user. For example, the user could set it so that only team games that are played on Saturdays are automatically added to the calendar.

In other embodiments, the process of adding the events to the calendar is semi-automatic rather than fully automatic. In such cases, the user is prompted at the time of a purchase of tickets, or some other initiating event (such as viewing the item, adding the tickets to the shopping cart, or establishing a subscription) to add the event to the calendar.

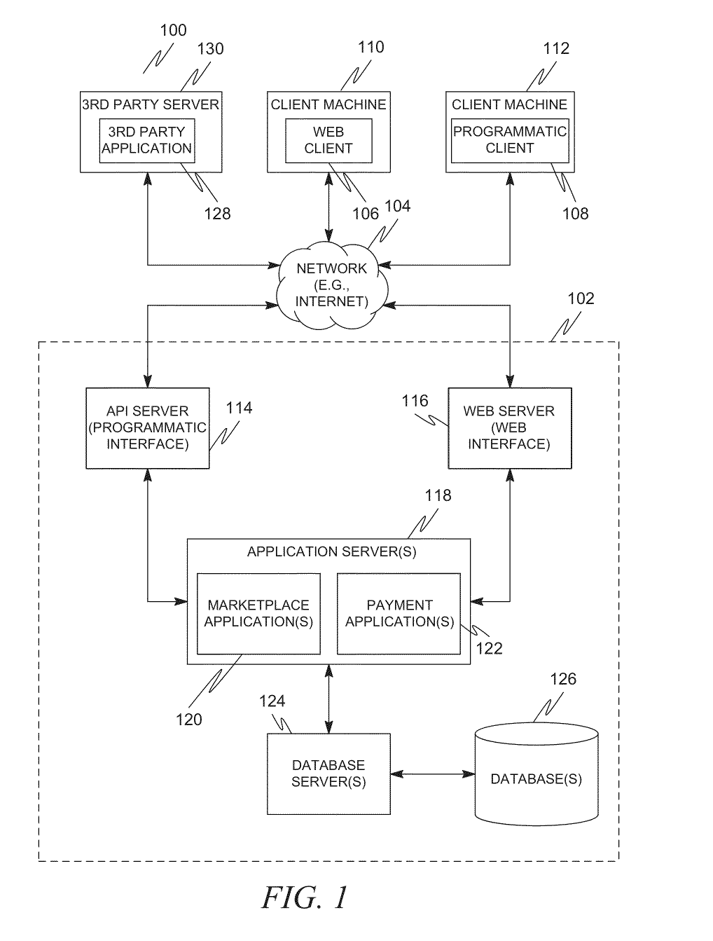

FIG. 1 is a network diagram depicting a client-server system 100, within which one example embodiment may be deployed. A networked system 102, in the example forms of a network-based marketplace or publication system, provides server-side functionality, via a network 104 (e.g., the Internet or a Wide Area Network (WAN)) to one or more clients. FIG. 1 illustrates, for example, a web client 106 (e.g., a browser, such as the Internet Explorer browser developed by Microsoft Corporation of Redmond, Wash. State) and a programmatic client 108 executing on respective client machines 110 and 112.

An API server 114 and a web server 116 are coupled to, and provide programmatic and web interfaces respectively to, one or more application servers 118. The application servers 118 host one or more marketplace applications 120 and payment applications 122. The application servers 118 are, in turn, shown to be coupled to one or more databases servers 124 that facilitate access to one or more databases 126.

The marketplace applications 120 may provide a number of marketplace functions and services to users who access the networked system 102. The payment applications 122 may likewise provide a number of payment services and functions to users. The payment applications 122 may allow users to accumulate value (e.g., in a commercial currency, such as the U.S. dollar, or a proprietary currency, such as “points”) in accounts, and then later to redeem the accumulated value for products (e.g., goods or services) that are made available via the marketplace applications 120. While the marketplace and payment applications 120 and 122 are shown in FIG. 1 to both form part of the networked system 102, it will be appreciated that, in alternative embodiments, the payment applications 122 may form part of a payment service that is separate and distinct from the networked system 102.

Further, while the system 100 shown in FIG. 1 employs a client-server architecture, the embodiments are, of course not limited to such an architecture, and could equally well find application in a distributed, or peer-to-peer, architecture system, for example. The various marketplace and payment applications 120 and 122 could also be implemented as standalone software programs, which do not necessarily have networking capabilities.

The web client 106 accesses the various marketplace and payment applications 120 and 122 via the web interface supported by the web server 116. Similarly, the programmatic client 108 accesses the various services and functions provided by the marketplace and payment applications 120 and 122 via the programmatic interface provided by the API server 114. The programmatic client 108 may, for example, be a seller application (e.g., the TurboLister application developed by eBay Inc., of San Jose, Calif.) to enable sellers to author and manage listings on the networked system 102 in an off-line manner, and to perform batch-mode communications between the programmatic client 108 and the networked system 102.

FIG. 1 also illustrates a third party application 128, executing on a third party server machine 130, as having programmatic access to the networked system 102 via the programmatic interface provided by the API server 114. For example, the third party application 128 may, utilizing information retrieved from the networked system 102, support one or more features or functions on a website hosted by the third party. The third party website may, for example, provide one or more promotional, marketplace, or payment functions that are supported by the relevant applications of the networked system 102.

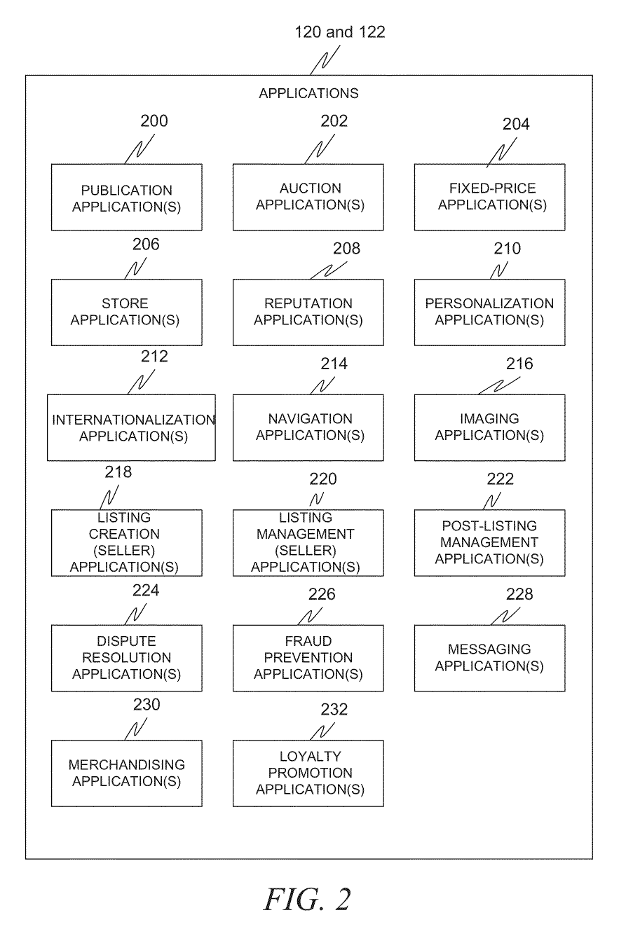

FIG. 2 is a block diagram illustrating multiple applications 120 and 122 that, in one example embodiment, are provided as part of the networked system 102. The applications 120 and 122 may be hosted on dedicated or shared server machines (not shown) that are communicatively coupled to enable communications between server machines. The applications themselves are communicatively coupled (e.g., via appropriate interfaces) to each other and to various data sources, so as to allow information to be passed between the applications or so as to allow the applications to share and access common data. The applications may furthermore access server one or more databases 126 via the database servers 124.

The networked system 102 may provide a number of publishing, listing, and price-setting mechanisms whereby a seller may list (or publish information concerning) goods or services for sale, a buyer can express interest in or indicate a desire to purchase such goods or services, and a price can be set for a transaction pertaining to the goods or services. To this end, the marketplace applications 120 and 122 are shown to include at least one publication application 200 and one or more auction applications 202, which support auction-format listing and price setting mechanisms (e.g., English, Dutch, Vickrey, Chinese, Double, Reverse auctions etc.). The various auction applications 202 may also provide a number of features in support of such auction-format listings, such as a reserve price feature whereby a seller may specify a reserve price in connection with a listing and a proxy-bidding feature whereby a bidder may invoke automated proxy bidding.

A number of fixed-price applications 204 support fixed-price listing formats (e.g., the traditional classified advertisement-type listing or a catalogue listing) and buyout-type listings. Specifically, buyout-type listings (e.g., including the Buy-It-Now (BIN) technology developed by eBay Inc., of San Jose, Calif.) may be offered in conjunction with auction-format listings, and allow a buyer to purchase goods or services, which are also being offered for sale via an auction, for a fixed-price that is typically higher than the starting price of the auction.

Store applications 206 allow a seller to group listings within a “virtual” store, which may be branded and otherwise personalized by and for the seller. Such a virtual store may also offer promotions, incentives, and features that are specific and personalized to a relevant seller.

Reputation applications 208 allow users who transact, utilizing the networked system 102, to establish, build, and maintain reputations, which may be made available and published to potential trading partners. Consider that where, for example, the networked system 102 supports person-to-person trading, users may otherwise have no history or other reference information whereby the trustworthiness and credibility of potential trading partners may be assessed. The reputation applications 208 allow a user (for example, through feedback provided by other transaction partners) to establish a reputation within the networked system 102 over time. Other potential trading partners may then reference such a reputation for the purposes of assessing credibility and trustworthiness.

Personalization applications 210 allow users of the networked system 102 to personalize various aspects of their interactions with the networked system 102. For example a user may, utilizing an appropriate personalization application 210, create a personalized reference page at which information regarding transactions to which the user is (or has been) a party may be viewed. Further, a personalization application 210 may enable a user to personalize listings and other aspects of their interactions with the networked system 102 and other parties.

The networked system 102 may support a number of marketplaces that are customized, for example, for specific geographic regions. A version of the networked system 102 may be customized for the United Kingdom, whereas another version of the networked system 102 may be customized for the United States. Each of these versions may operate as an independent marketplace or may be customized (or internationalized) presentations of a common underlying marketplace. The networked system 102 may accordingly include a number of internationalization applications 212 that customize information (and/or the presentation of information) by the networked system 102 according to predetermined criteria (e.g., geographic, demographic or marketplace criteria). For example, the internationalization applications 212 may be used to support the customization of information for a number of regional websites that are operated by the networked system 102 and that are accessible via respective web servers 116.

Navigation of the networked system 102 may be facilitated by one or more navigation applications 214. For example, a search application (as an example of a navigation application) may enable key word searches of listings published via the networked system 102. A browse application may allow users to browse various category, catalogue, or inventory data structures according to which listings may be classified within the networked system 102. Various other navigation applications may be provided to supplement the search and browsing applications.

In order to make listings, available via the networked system 102, as visually informing and attractive as possible, the marketplace applications 120 may include one or more imaging applications 216, which users may utilize to upload images for inclusion within listings. An imaging application 216 also operates to incorporate images within viewed listings. The imaging applications 216 may also support one or more promotional features, such as image galleries that are presented to potential buyers. For example, sellers may pay an additional fee to have an image included within a gallery of images for promoted items.

Listing creation applications 218 allow sellers to conveniently author listings pertaining to goods or services that they wish to transact via the networked system 102, and listing management applications 220 allow sellers to manage such listings. Specifically, where a particular seller has authored and/or published a large number of listings, the management of such listings may present a challenge. The listing management applications 220 provide a number of features (e.g., auto-relisting, inventory level monitors, etc.) to assist the seller in managing such listings. One or more post-listing management applications 222 also assist sellers with a number of activities that typically occur post-listing. For example, upon completion of an auction facilitated by one or more auction applications 202, a seller may wish to leave feedback regarding a particular buyer. To this end, a post-listing management application 222 may provide an interface to one or more reputation applications 208, so as to allow the seller conveniently to provide feedback regarding multiple buyers to the reputation applications 208.

Dispute resolution applications 224 provide mechanisms whereby disputes arising between transacting parties may be resolved. For example, the dispute resolution applications 224 may provide guided procedures whereby the parties are guided through a number of steps in an attempt to settle a dispute. In the event that the dispute cannot be settled via the guided procedures, the dispute may be escalated to a third party mediator or arbitrator.

A number of fraud prevention applications 226 implement fraud detection and prevention mechanisms to reduce the occurrence of fraud within the networked system 102.

Messaging applications 228 are responsible for the generation and delivery of messages to users of the networked system 102 (such as, for example, messages advising users regarding the status of listings at the networked system 102 (e.g., providing “outbid” notices to bidders during an auction process or to provide promotional and merchandising information to users). Respective messaging applications 228 may utilize any one of a number of message delivery networks and platforms to deliver messages to users. For example, messaging applications 228 may deliver electronic mail (e-mail), instant message (IM), Short Message Service (SMS), text, facsimile, or voice (e.g., Voice over IP (VoIP)) messages via the wired (e.g., the Internet), Plain Old Telephone Service (POTS), or wireless (e.g., mobile, cellular, WiFi, WiMAX) networks.

Merchandising applications 230 support various merchandising functions that are made available to sellers to enable sellers to increase sales via the networked system 102. The merchandising applications 230 also operate the various merchandising features that may be invoked by sellers, and may monitor and track the success of merchandising strategies employed by sellers.

The networked system 102 itself, or one or more parties that transact via the networked system 102, may operate loyalty programs that are supported by one or more loyalty/promotions applications 232. For example, a buyer may earn loyalty or promotion points for each transaction established and/or concluded with a particular seller, and be offered a reward for which accumulated loyalty points can be redeemed.

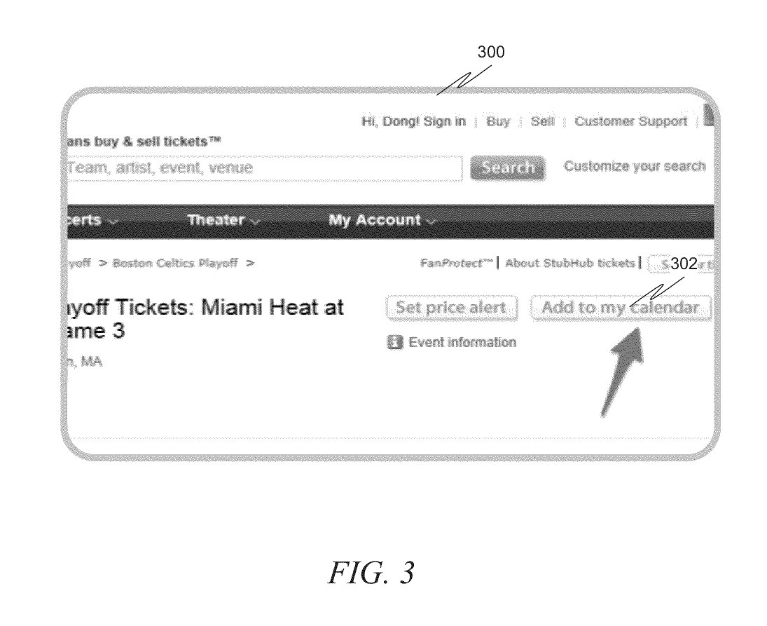

FIG. 3 is a screen capture illustrating an embodiment on a desktop or laptop device, in accordance with one embodiment. Here, the user is viewing playoff tickets on a web page 300. An additional button 302 is added to the web page allowing the user to indicate that he or she wishes to add it to his or her calendar. Here, the web site is a StubHub event page, and the calendar is an Outlook calendar. Adding the event to the calendar while only viewing the tickets may be beneficial if, for example, the user does not have time or is otherwise unable to make a decision as to whether to purchase right now, but wishes to have a reminder that the event is happening so he or she can decide later (such as when he or she gets home from work).

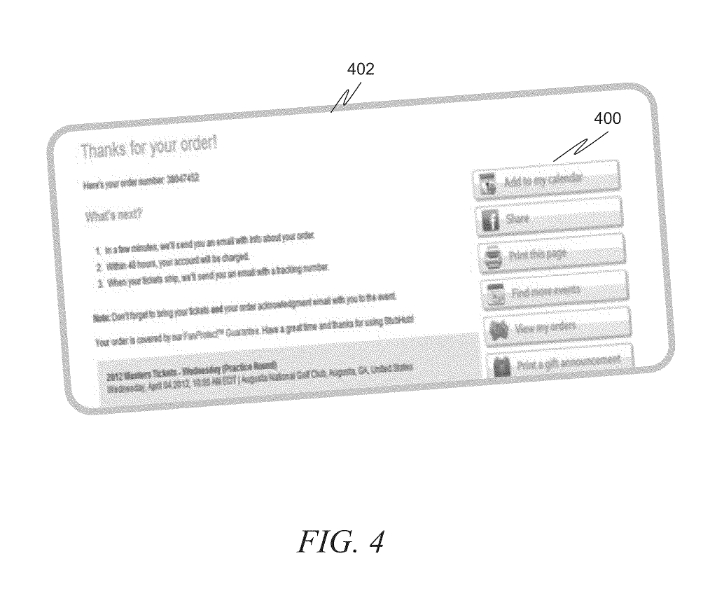

FIG. 4 is a screen capture illustrating an embodiment where the user is prompted to add the event to his or her calendar after purchasing the tickets, in accordance with one embodiment. Specifically, a button 400 appears on an order confirmation page 402 that permits the user to indicate that he or she wishes to have the event added to his or her calendar. This button could also appear in a web-formatted (e.g., hypertext markup language (HTML)) email confirmation sent to the user.

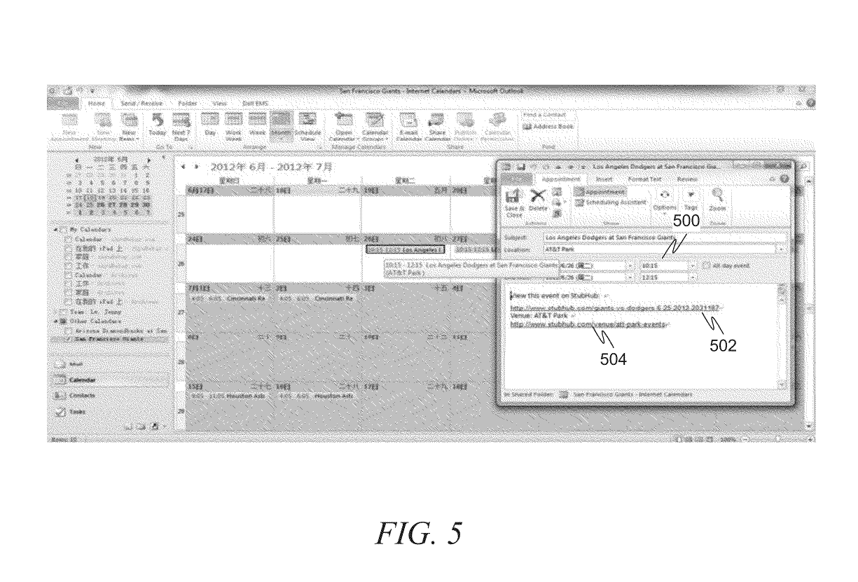

The form in which the event is added to the user's calendar can also vary depending on implementation. In one example, the event title, time, and date are all added as a calendar entry. In another example, a link is provided to the ticket purchase web site, as well as to the location of the event. FIG. 5 is a screen capture illustrating the latter embodiment. As can be seen, the event appears on the user's calendar and includes the date and time 500, a link to the purchase web site 502, and a link to the venue 504. Obviously the link to the purchase web site 502 may be more important in situations where the event has been added to the calendar prior to the user having purchased tickets for the event. In that case, the user is able to easily follow the link to the ticket web page to buy the tickets. The link to the venue 504 may be useful in determining directions, but also for notifications of changes (e.g., game cancellations, changes in concert times, promotions, etc.). In another example, the title may be appended with the phrase “tickets not purchased yet” as an additional reminder (not pictured).

In an even further example, the calendar application itself may be tied back to the web site offering the tickets, allowing it to provide a real-time status of the tickets. For example, it could say “tickets still available” if the tickets have not sold yet. It could also list the current price, if the price is such that it does not remain fixed over time (such as in the case of an auction, or simply a markdown or markup by the seller). In other words, it can be populated with dynamic information instead of merely static information common to calendar applications.

While the above embodiments depict the user controlling precisely when to add the event to the calendar, the system may perform some or all of that decision-making automatically in some embodiments, as described earlier. In a fully automatic mode, anytime the user purchases tickets, a calendar event is added for those tickets. Obviously a fully automatic mode may have some limitations when attempting to add events for tickets that the user has not actually purchased (e.g., the user simply went to the web site and viewed the tickets but did not buy). Specifically, the question arises as to whether the user was interested enough in the event to have the event automatically added to his or her calendar, or whether it would be inappropriate to do so (e.g., if the user was “just browsing,” or determined that he or she could not attend, or that it simply was too expensive). In some embodiments, it may be possible for the system to automatically detect the user's intent even when the user has not actually proceeded with a purchase. For example, some web sites have “shopping carts,” where a user can add items to the cart but not actually check out and purchase the items until a later time. The system may assume that if the user got to the point where he or she has added the tickets to a shopping cart, then the interest level is enough to warrant automatically adding the event to the user's calendar.

Some web sites additionally allow users to add an item as a “save for later,” as opposed to a true shopping cart. In some embodiments, the system may assume that tickets added to such a “save for later” list are enough to warrant automatically adding the event to the user's calendar.

In other embodiments, the addition of the events to the calendar may be partially automatic. Specifically, the user could specify certain settings that, when implemented, would allow the system to automatically add events to the calendar under certain circumstances. For example, the user could indicate that any events for which tickets have been purchased can be automatically added to the calendar without user intervention, whereas events for which tickets have merely been added to a shopping cart should cause the system to prompt the user to decide whether to add the particular event to the calendar.

In other embodiments, other user actions can indicate an interest in an event sufficient to warrant the system adding the event automatically to the user calendar, or at least prompting the user as to whether the event should be added to the calendar. For example, even without the user setting up an explicit subscription, the system could determine that the user is a fan of a particular sports team and automatically or semi-automatically add games for that sports team to a calendar. This may be determined implicitly in a number of different ways. For example, the system could track web searches and determine that a large number of searches are performed that include the team name, names of players who are on the team, and/or the sport in general. In another example, the system could track visits to web sites and determine that the user is a fan of a particular team from web usage (i.e., web sites the user visits, search terms the user types in search engines, and purchases the user makes at other web sites, such as sports paraphernalia). In one embodiment, an intelligent learning algorithm can be used to learn the user's tendencies over time and determine team or other preference information from general computer usage. In another example, user communications may be monitored to determine team or other preference information. For example, user emails could be parsed and key terms extracted. The system may then determine preference information, such as favorite team, by virtue of the frequency of usage of key terms.

Of course, while the above paragraph discusses these embodiments in terms of favorite sports teams, one of ordinary skill in the art would recognize that these embodiments, like all the embodiments, could be applied to other types of events. For example, the system could deduce that the user is a fan of certain musical artists and automatically add a concert that one of the artists has planned for a certain day in the user's home town.

In some embodiments, the system may utilize information about the user's location in order to determine which events to add automatically. In the sports team example, the system may only automatically add games that are scheduled for the user's home town. In such an embodiment, the user could still add games scheduled for other locations through the manual method described earlier (e.g., buttons available after a user makes a purchase or adds tickets to a shopping cart, etc.).

The system may also make assumptions about the user's location on days of events in order to determine which events to add to the user's calendar automatically. For example, while the user may be a Green Bay Packers fan and may live in Wisconsin, the system may be intelligent enough to deduce that the user may be in New York on a certain weekend from the purchase of plane tickets and hotel reservations made on the computer, and therefore may be able to add a game between the Green Bay Packers and the New York Giants played in New York on that weekend to the calendar automatically.

In some embodiments, the intelligence for determining when to automatically add an event to a user's calendar may be located on a server. In some instances this server may be operated by, for example, the ticket seller website or other event facilitator. In such embodiments, to the extent that the system needs user information not at its disposal in order to make a determination as to whether to automatically add an event to a user's calendar, it can obtain such information from other sources, such as other servers or a client program operating on the user's computer or smartphone. For example, information such as ticket purchases the user makes on the ticket provider website, or which tickets he or she added to a shopping cart or a “save for later” list, may already be available at the server. But more user-centric information such as other web sites the user visited and email communications from the user may be located on a client program and may need to be retrieved prior to making the analysis.

In other embodiments, the intelligence for determining when to automatically add an event to a user's calendar may reside on a client program operating on the user's computer or smartphone. In other embodiments, the intelligence may be shared between server and client, or even between multiple servers. The present claims shall not be interpreted as limited to any particular embodiment unless expressly stated.

In other embodiments, other events than merely sports events and concerts can be automatically added to the user's calendar using the above mechanisms. Indeed, embodiments could be applied to any type of event that would be appropriate to add to a calendar. Specifically, any event having a date and time could be added to a user's calendar. This includes events such as meetings, auction listing closing times, sales, airplane flights, hotel stays, and so forth.

It should be noted that the scope of this document is not limited to web-based implementations. Any electronic interfaces, such as Application Program Interfaces (APIs), can be utilized to implement aspects of embodiments presented herein, not just web interfaces.

In one embodiment, the system is integrated within a payment system (e.g., PayPal™) so that any items purchased using the payment system could potentially be used to determine if events should be added to a user's calendar. This may include adding an event based on the purchase itself (e.g., the user pays for concert tickets via PayPal™, even if the underlying ticket seller platform is not integrated with the calendaring system), or may include adding an event indirectly related to the purchase (e.g., determining that the user is a Green Bay Packers fan by virtue of the user having purchased Green Bay Packet paraphernalia via PayPal™)

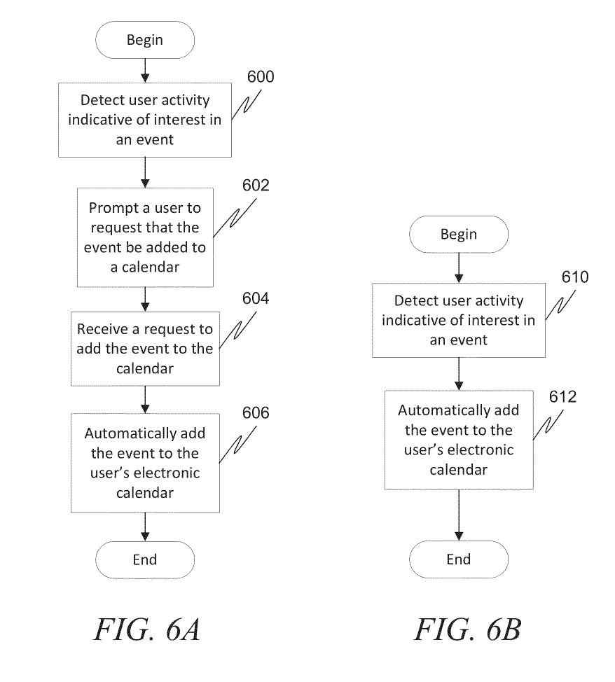

FIG. 6A is a flow diagram illustrating a method, in accordance with one embodiment. At 600, user activity indicative of interest in an event is detected, by examining user activity outside of an electronic calendar corresponding to the user. The event has a date and time. User activity outside of an electronic calendar includes any activity that doesn't involve the user interfacing directly with an electronic calendar application. Such direct calendar activities would include adding a calendar entry, deleting a calendar entry, editing a calendar entry, sending an appointment or meeting request, or any other action taken within the confines of an electronic calendar application. At 602, the user is prompted to request that the event be added to a calendar. At 604, a request to add the event to the calendar is received. At 606, the event is automatically added to the electronic calendar corresponding to the user upon receipt of the request that the event be added to the calendar.

FIG. 6B is a flow diagram illustrating a method, in accordance with another embodiment. At 610, a user action indicative of interest in an event is detected, by examining user activity outside of an electronic calendar corresponding to the user. At 612, the event is automatically added to an electronic calendar corresponding to the user upon a determination that the user's interest in the event is sufficient to warrant adding the event to the user's calendar.

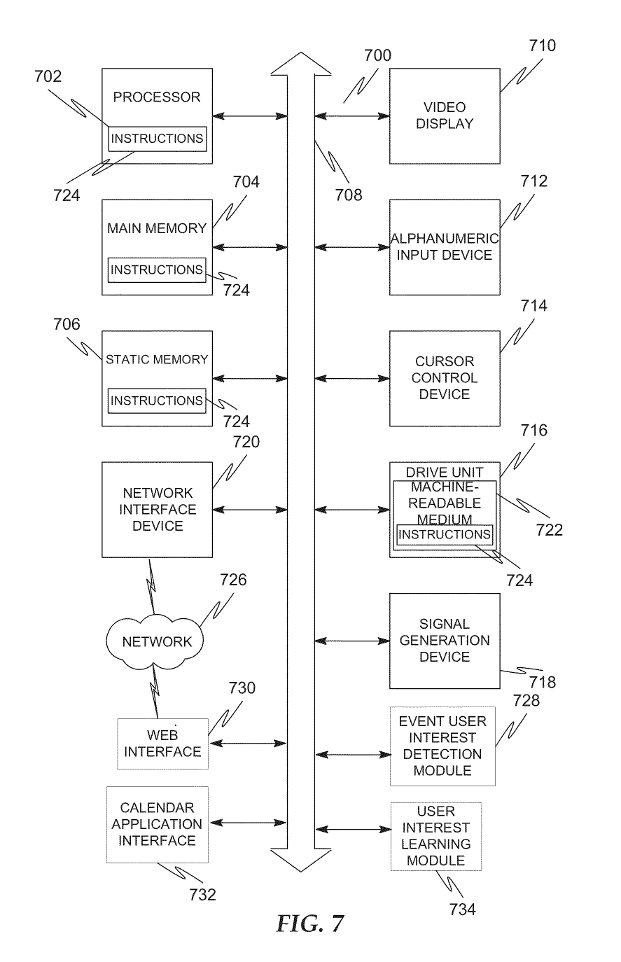

FIG. 7 shows a diagrammatic representation of machine in the example form of a computer system 700 within which a set of instructions, for causing the machine to perform any one or more of the methodologies discussed herein, may be executed. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a server computer, a client computer, a personal computer (PC), a tablet PC, a set-top box (STB), a personal digital assistant (PDA), a cellular telephone, a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 700 includes a processor 702 (e.g., a central processing unit (CPU), a graphics processing unit (GPU), or both), a main memory 704 and a static memory 706, which communicate with each other via a bus 708. The computer system 700 may further include a video display unit 710 (e.g., a liquid crystal display (LCD) or a cathode ray tube (CRT)). The computer system 700 also includes an alphanumeric input device 712 (e.g., a keyboard), a cursor control device 714 (e.g., a mouse), a disk drive unit 716, a signal generation device 718 (e.g., a speaker), and a network interface device 720.

The disk drive unit 716 includes a machine-readable medium 722 on which is stored one or more sets of instructions (e.g., software 724) embodying any one or more of the methodologies or functions described herein. The software 724 may also reside, completely or at least partially, within the main memory 704 and/or within the processor 702 during execution thereof by the computer system 700, with the main memory 704 and the processor 702 also constituting machine-readable media. The software 724 may further be transmitted or received over a network 726 via the network interface device 720.

While the machine-readable medium 722 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies described herein. The term “machine-readable medium” shall accordingly be taken to include, but not be limited to, solid-state memories, optical and magnetic media, and carrier wave signals.

An event user interest detection module 728 may be configured to detect a user interest in an event. A web interface 730 may be configured to prompt the user to request that the event be added to a calendar. A calendar application interface 732 may be configured to automatically add the event to an electronic calendar corresponding to the user upon receipt of a request that the event be added to the calendar. A user interest learning module 734 may be configured to execute a learning algorithm designed to determine user interest in the event based upon usage of a device operated by the user.

Although the inventive concepts been described with reference to specific example embodiments, it will be evident that various modifications and changes may be made to these embodiments without departing from the broader spirit and scope of the inventive concepts. Accordingly, the specification and drawings are to be regarded in an illustrative rather than a restrictive sense.

The Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment.

1. A method comprising:
detecting a user action indicative of interest in an event by examining user activity outside of an electronic calendar corresponding to the user, the event having a time and date;
prompting the user to request that the event be added to a calendar; and
automatically adding the event to the electronic calendar corresponding to the user upon receipt of a request that the event be added to the calendar.

2. The method of claim 1, wherein the detected user action is a user purchase of a ticket to the event.

3. The method of claim 2, wherein the prompting includes providing a button on an order confirmation interface confirming the purchase of the ticket.

4. The method of claim 1, wherein the detected user action is adding a ticket to the event to a shopping cart of a web site.

5. The method of claim 1, wherein the user interest is determined by the user indicating a subscription to an event grouping that includes the event.

6. The method of claim 5, wherein the event grouping includes season tickets.

7. The method of claim 1, wherein the automatically adding includes adding a link to a venue for the event in a calendar entry corresponding to the event.

8. The method of claim 2, wherein the automatically adding includes adding a link to a website where the a ticket was purchased in a calendar entry corresponding to the event.

9. The method of claim 2, wherein the automatically adding includes adding a dynamically updating element showing a current price for a ticket to the event.

10. A method comprising:
detecting a user action indicative of interest in an event by examining user activity outside of an electronic calendar corresponding to the user, the event having a time and date; and
automatically adding the event to the electronic calendar corresponding to the user upon a determination that the user's interest in the event is sufficient to warrant adding to the user's calendar.

11. The method of claim 10, wherein the detecting includes detecting that the user has purchased a ticket to the event.

12. The method of claim 10, wherein the detecting includes determining that the user is a fan of a sports team participating in the event by examining past purchases by the user.

13. The method of claim 10, wherein the detecting includes determining that the user is a fan of a sports team participating in the event by examining prior web searches by the user.

14. The method of claim 10, wherein the detecting includes determining that the user is a fan of a sport team participating in the event by examining prior web usage by the user.

15. A computer-implemented system comprising:
at least one processor coupled to a memory;
an event user interest detection module configured to detect a user action indicative of interest in an event by examining user activity outside of an electronic calendar corresponding to the user, the event having a time and date;
a web interface configured to prompt the user to request that the event be added to a calendar; and
a calendar application interface configured to automatically add the event to the electronic calendar corresponding to the user upon receipt of a request that the event be added to the calendar.

16. The system of claim 15, further comprising a calendar application operating on a user device, wherein the calendar application is configured to display and update the electronic calendar.

17. The system of claim 16, wherein the user device is a mobile device.

18. The system of claim 16, wherein the user device is a laptop computer.

19. The system of claim 16, wherein the user device is a desktop computer.

20. A computer-implemented system comprising:
at least one processor coupled to a memory;
an event user interest detection module configured to detect a user action indicative of interest in an event, the event having a time and date; and
a calendar application interface configured to automatically add the event to the electronic calendar corresponding to the user upon a determination that the user's interest in the event is sufficient to warrant adding to the user's calendar.

21. The system of claim 20, further comprising a user interest learning module configured to execute a learning algorithm designed to determine user interest in the event based upon usage of a device operated by the user.

22. A machine-readable non-transitory storage medium having instruction data to cause a machine to execute a method comprising:
detecting a user action indicative of interest in an event by examining user activity outside of an electronic calendar corresponding to the user, the event having a time and date;
prompting the user to request that the event be added to a calendar; and
automatically adding the event to the electronic calendar corresponding to the user upon receipt of a request that the event be added to the calendar.

23. A machine-readable non-transitory storage medium having instruction data to cause a machine to execute a method comprising:
detecting a user action indicative of interest in an event by examining user activity outside of an electronic calendar corresponding to the user, the event having a time and date; and
automatically adding the event to the electronic calendar corresponding to the user upon a determination that the user's interest in the event is sufficient to warrant adding to the user's calendar.
